(19) United States
(12) Patent Application Publication
(10) Pub. No.: US 2006/0168817 A1
(43) Pub. Date: Aug. 3, 2006

(54) Folding knife

(76) Inventor: Chih-Chen Kao, Taoyuan City (TW)

Correspondence Address: BACON & THOMAS, PLLC, 625 SLATERS LANE, FOURTH FLOOR, ALEXANDRIA, VA, 22314, US

(21) Appl. No.: 11/045,298

(22) Filed: Jan. 31, 2005

(51) Int. Cl. B26B 3/06; F41B 13/02

(52) U.S. Cl. 30/153; 30/155

(57) ABSTRACT

The present invention is to provide a folding knife operable by one hand, comprising a handle and a blade. The blade comprises a point at one end along with the other end pivotably connected to one end of the handle and a latch pivotably connected to the other end, enabling the blade to be adapted to either lie within the handle by pivoting in one direction or pull out of the handle by pivoting in the other opposite direction and the latch to be adapted to lock with a detent of the handle for prohibiting the blade from pivoting when the blade is received in the handle in a closed position of the knife or the point is distal one end of the handle in an open position thereof.

### FIELD OF THE INVENTION

The present invention relates to folding tools and more particularly to a folding knife having a blade being adapted to either lie within a handle by pivoting in one direction or pull out of the handle by pivoting in the other opposite direction.

### BACKGROUND OF THE INVENTION

Conventionally, a folding knife comprises a handle and a blade having the other end pivotably connected to one end of the handle such that the blade is adapted to pivot about the handle. For receiving the blade a user may pivot the blade about the handle to lie within an internal groove of the handle open to one prong of the handle. In detail, for receiving the blade the user has to use one hand to hold the handle and use the other hand to pull the blade out of the groove into an open position by pivoting.

However, the prior folding knife suffered from a disadvantage. In brief, two hands are required to pull the blade out of the handle. This is an undesirably complicated construction. The folding knife may be useless if a person only can use one hand in an emergency. For example, a diver cannot use one hand to open the folding knife if unfortunately the other hand is tangled by fishing-net during diving. As such, life of the diver may be endangered in this situation since the carried compressed-air cylinder may consume in a predetermined period of time. Thus, it is desirable to provide an improved folding knife which, in addition to be easy in carrying and use, can be opened or closed by one hand in order to overcome the inadequacy of the prior art.

### SUMMARY OF THE INVENTION

After considerable research and experimentation, a novel folding knife according to the present invention has been devised so as to overcome the above drawback of the prior art.

It is an object of the present invention to provide a folding knife operable by one hand, comprising a handle and a blade. The blade comprises a point at one end and has the other end pivotably connected to one end of the handle. The blade is adapted to either lie within the handle by pivoting in one direction or pull out of the handle by pivoting in the other opposite direction. The blade further comprises a latch pivotably connected to the other end thereof. The latch is adapted to lock with a detent of the handle for prohibiting the blade from pivoting when the blade is received in the handle in a closed position of the knife or the point is distal one end of the handle in an open position thereof. The latch is also adapted to disengage from the detent for permitting the blade to pivot about the handle.

The above and other objects, features and advantages of the present invention will become apparent from the following detailed description taken with the accompanying drawings.

### BRIEF DESCRIPTION OF THE DRAWINGS

FIG. 1 is a perspective view of a preferred embodiment of folding knife according to the invention, showing the blade in its open position;

FIG. 2 is an exploded view of forward and intermediate portions of the knife, showing the handle to be assembled with the blade;

FIG. 3 is a side view of rear and intermediate portions of the knife, showing the blade in its closed position;

FIG. 4 is a side view of forward and intermediate portions of the knife in its open position, showing the latch at other end of the blade in a co-acting operation with the resilient element;

FIG. 5 is an exploded view of the folding knife; and

FIG. 6 is a view similar to FIG. 4 showing a latch mechanism of a folding knife according to another preferred embodiment of the invention.

### DETAILED DESCRIPTION OF THE PREFERRED EMBODIMENTS

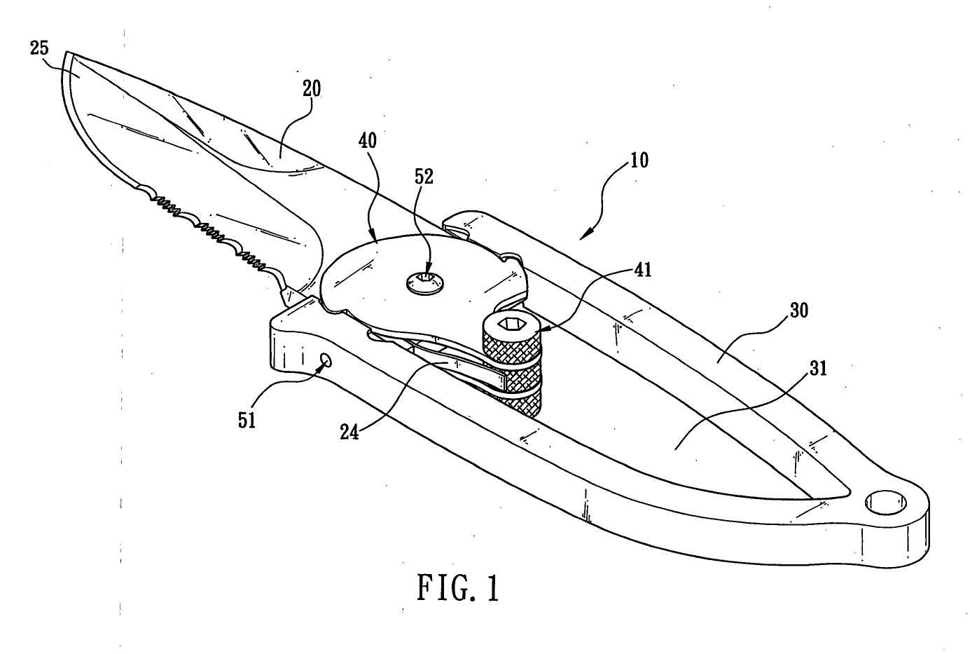

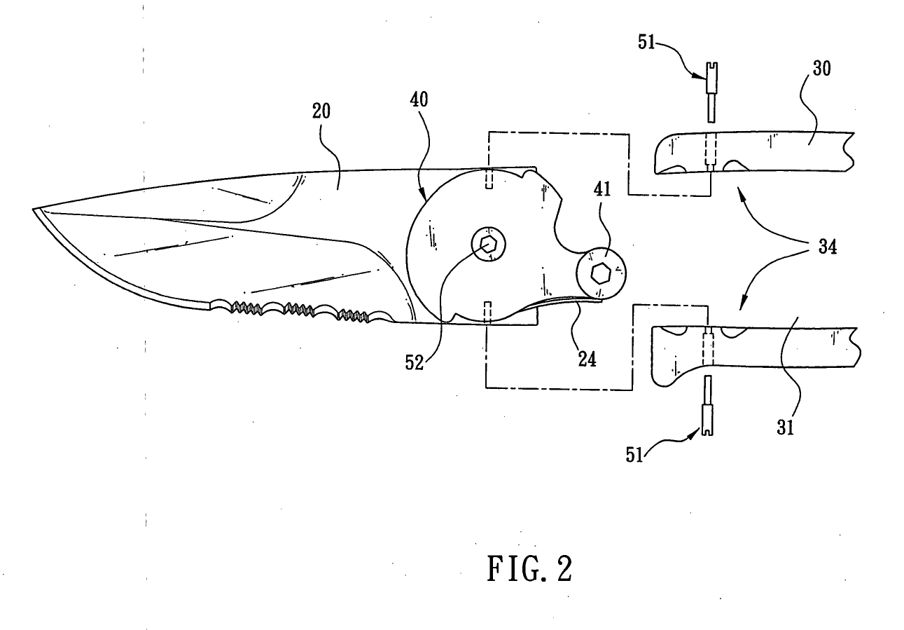

Referring to FIG. 1, there is shown a folding knife 10 according to a preferred embodiment of the invention. The knife 10 comprises a blade 20 and a handle 30. The handle 30 comprises a receiving space 31 for permitting the blade 20 to lie therein. The blade 20 comprises a point 25 at its one end. The other end of the blade 20 is pivotably connected to one end of the handle 30. The blade 20 is adapted to either lie within the receiving space 31 by pivoting in one direction or pull out of the receiving space 31 by pivoting in the other opposite direction. There is further provided a detent 34 at one end of the handle 30 (see FIG. 2). A latch 40 adapted to co-act with the detent 34 is provided at the other end of the blade 20. The latch 40 is locked with the detent 34 when the blade 20 is received in the receiving space 31 in a closed position of the knife 10 or the point 25 is distal one end of the handle 30 in an open position thereof. A user may easily use the blade 20 in the open position or carry the knife 10 in the closed position since the blade 20 is in a fixed relationship with respect to the handle 30 at either state. Alternatively, a user may manipulate the knife 10 to disengage the locking state of the latch 40 and the detent 34. The blade 20 is able to pivot about the handle 30 after disengaging the locking state.

Referring to FIG. 1 again, a proximate end of the blade 20 (e.g., the other end thereof) is pivotably connected to one end of the handle 30 by a first pivot axis 51. As such, the blade 20 is adapted to pivot about the handle 30 by turning on the first pivot axis 51. The proximate end of the blade 20 (e.g., the other end thereof) is also pivotably connected to the latch 40 by a second pivot axis 52. The second pivot axis 52 is perpendicular with respect to the first pivot axis 51. As such, the latch 40 is adapted to pivot about the handle 30 by turning on the second pivot axis 52.

Referring to FIG. 1 again, the receiving space 31 is defined by an inner surface extended from one prong to the other prong of the handle 30. That is, the receiving space 31 is open to both sides. One end of the receiving space 31 is extended out of one end of the handle 30, resulting in a V-shaped (or U-shaped) handle 30. One end of the blade 20 is thus able to pivot about the handle 30 by turning on the first pivot axis 51 to lie within the receiving space 31. In this closed position, the cutting edge of the blade 20 is concealed in the handle 30 for prohibiting from hurting a user or another person inadvertently. The open configuration of the receiving space 31 aims at allowing the blade 20 to pivot about the handle 30 by turning on the first pivot axis 51 in either direction (e.g., clockwise or counterclockwise). In such configuration, a user may use the right hand or left hand to manipulate the knife 10.

Referring to FIG. 2 in conjunction with FIG. 1, the latch 40 comprises an engagement member 41 pivotably connected to the other end of the blade 20. That is, the engagement member 41 is distal the point 25 and the blade 20 is pivotal about the engagement member 41. Also, a resilient element 24 is provided at the other end of the blade 20 distal the point 25 and is extended away from the other end of the blade 20. The resilient element 24 has a sufficient length to contact the engagement member 41 at its one side when the blade 20 and the latch 40 are pivotably connected together.

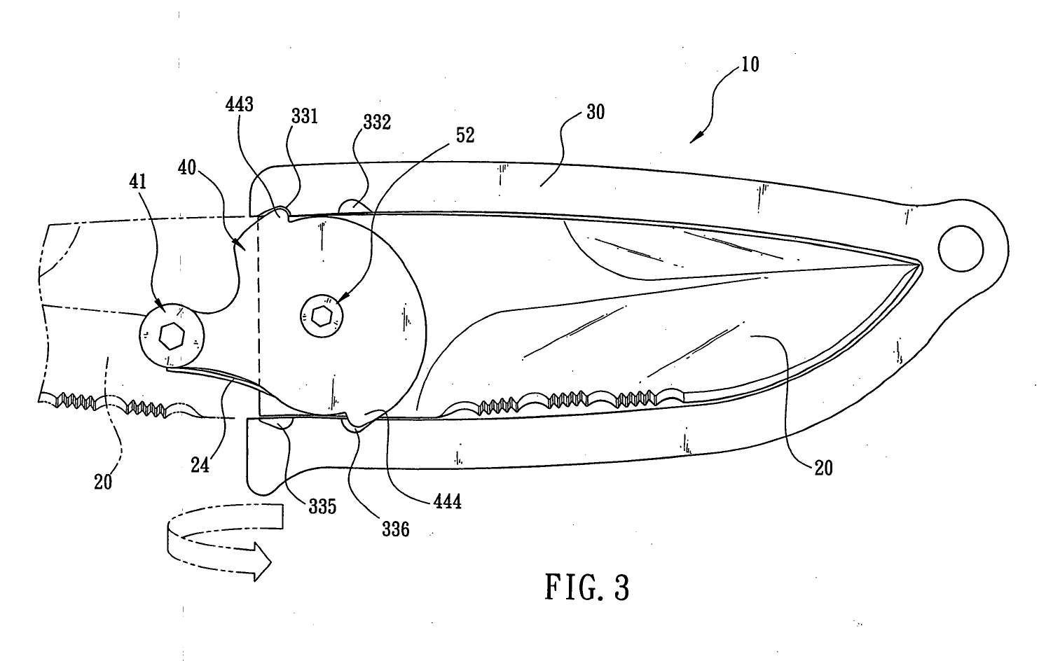

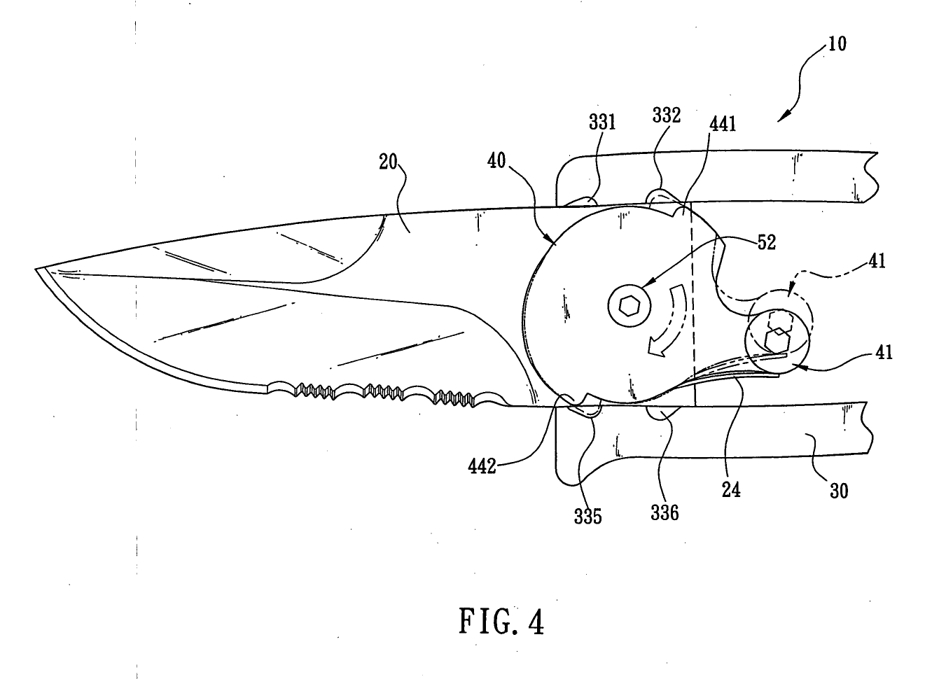

Referring to FIG. 3, in a case of the blade 20 received in the receiving space 31 or the point 25 is opposite the other end of the handle 30 in an open position of the knife 10 (see FIG. 1), the engagement member 41 is always disposed between the resilient element 24 and one prong of the handle 30. The resilient element 24 is adapted to move the engagement member 41 toward one prong of the handle 30 for locking the latch 40 and the detent 34 together. Moreover, referring to FIG. 4, during using the knife 10 move the engagement member 41 toward the other prong of the handle 30 for deflecting a free end of the resilient element 24 a predetermined angle. At this position, the locking state of the latch 40 and the detent 34 is disengaged. As an end, the blade 20 is adapted to pivot about the handle 30.

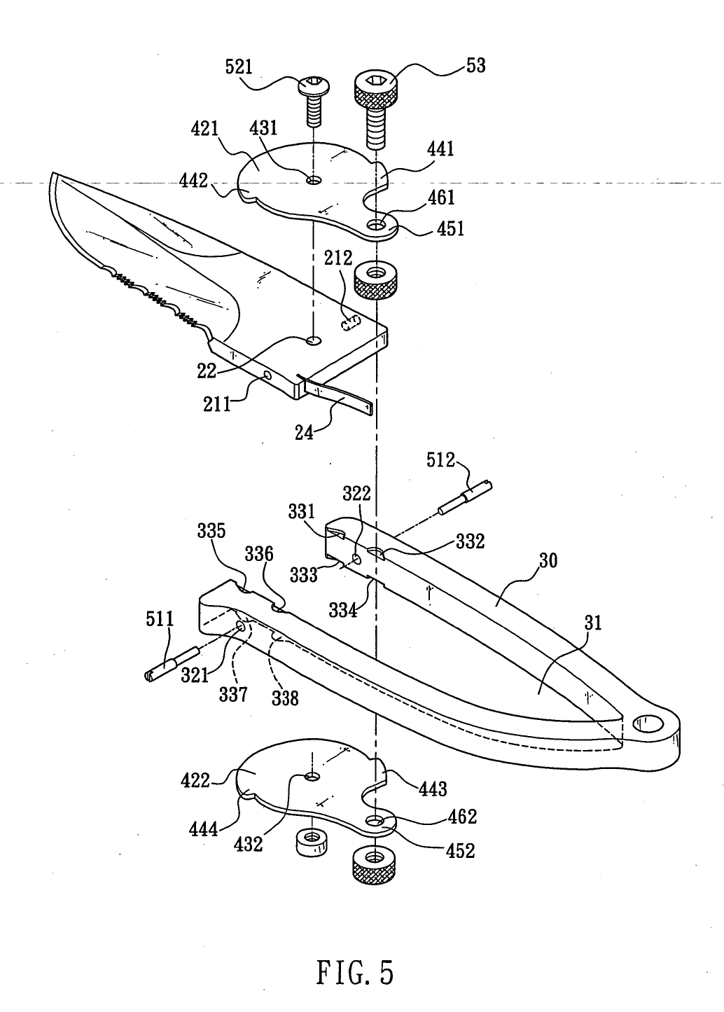

Referring to FIG. 5, in one preferred embodiment of the invention a first through hole 321 is formed proximate one end of the handle 30 and a second through hole 322 is formed proximate the other opposite end of the handle 30 both at the detent 34 (see FIG. 2). Correspondingly, a first hole 211 is formed at one edge proximate the other end of the blade 20 and a second hole 212 is formed at the other edge proximate the other end of the blade 20 both distal the point 25 (see FIG. 1). The first hole 211 is aligned with the first through hole 321 and the second hole 212 is aligned with the second through hole 322. Two pivot elements (e.g., screws) 511 and 512 each is adapted to drive through the first through hole 321 (or second through hole 322) into the first hole 211 (or second hole 212) for pivotably fastening the blade 20. That is, the blade 20 is adapted to pivot about the first pivot axis 51.

Referring to FIG. 5 again, in the preferred embodiment the latch 40 of FIG. 1 comprises two opposite first and second latching elements 421 and 422. The latching element 421 (or 422) comprises a central aperture 431 (or 432). The other end of the blade 20 is received and sandwiched between the latching elements 421 and 422. An opening 22 is formed between the holes 211 and 212 at the other end of the blade 20. The opening 22 is adapted to cooperate with the apertures 431 and 432 at the other end of the blade 20. The opening 22 is aligned with the apertures 431 and 432 when the other end of the blade 20 is pivotably connected between the latching elements 421 and 422. A fastener (e.g., bolt and nut combination) 521 is driven through one aperture 431, the opening 22, and the other aperture 432 such that the fastener 521 can be served as the second pivot axis 52.

Referring to FIG. 5 again, the engagement member 41 shown in the preferred embodiment (see FIG. 1) is provided at a periphery of either latching element 421 or 422 with two projecting catches 451 and 452 formed thereat. A hole 461 is formed in the catch 451 and another hole 462 is formed in the catch 452. A fastener (e.g., bolt and nut combination) 53 is driven through the holes 461 and 462 such that the engagement member 41 can be fastened in the preferred embodiment.

Referring to FIG. 5 again, in the preferred embodiment the detent 34 shown in FIG. 2 is embodied as below. The first through hole 321 is formed proximate one end of the handle 30 and the second through hole 322 is formed proximate the other opposite end of the handle 30. On an inner surface of the handle 30 proximate the second through hole 322 there are provided first recess 331, second recess 332, third recess 333, and fourth recess 334 and on the inner surface of the handle 30 proximate the first through hole 321 there are provided fifth recess 335, sixth recess 336, seventh recess 337, and eighth recess 338. A first protuberance 441 and an opposite second protuberance 442 are formed at a periphery of the latching element 421 and a third protuberance 443 and an opposite fourth protuberance 444 are formed at a periphery of the latching element 422. Each of the protuberances 441, 442, 443, and 444 is adapted to neatly engage with one of the recesses 331, 332, 333, 334, 335, 336, 337, and 338 when the latch 40 and the detent 34 are in a locking state as conceived by the preferred embodiment of the invention.

Referring to FIGS. 3 and 5 again, the first protuberance 441 is engaged with the third recess 333, the second protuberance 442 is engaged with the eighth recess 338, the third protuberance 443 is engaged with the first recess 331, and the fourth protuberance 441 is engaged with the sixth recess 336 when the blade 20 lies within the receiving space 31 as shown in FIG. 1. To the contrary as shown in FIGS. 4 and 5, during using the knife 10 move the engagement member 41 toward the other prong of the handle 30 for deflecting the free end of the resilient element 24 a predetermined angle. At this position, the locking states of the first protuberance 441 and the third recess 333, the second protuberance 442 and the eighth recess 338, the third protuberance 443 and the first recess 331, and the fourth protuberance 441 and the sixth recess 336 are disengaged. Next, it is adapted to pivot the blade 20 to cause the point 25 to pivot into an open position (i.e., distal the other end of the handle 30). At this time, the resilient element 24 returns to its original position with the first protuberance 441 engaged with the second recess 332, the second protuberance 442 engaged with the fifth recess 335, the third protuberance 443 engaged with the fourth recess 334, and the fourth protuberance 441 engaged with the seventh recess 337. This brings the blade 20 and the handle 30 in a locking state.

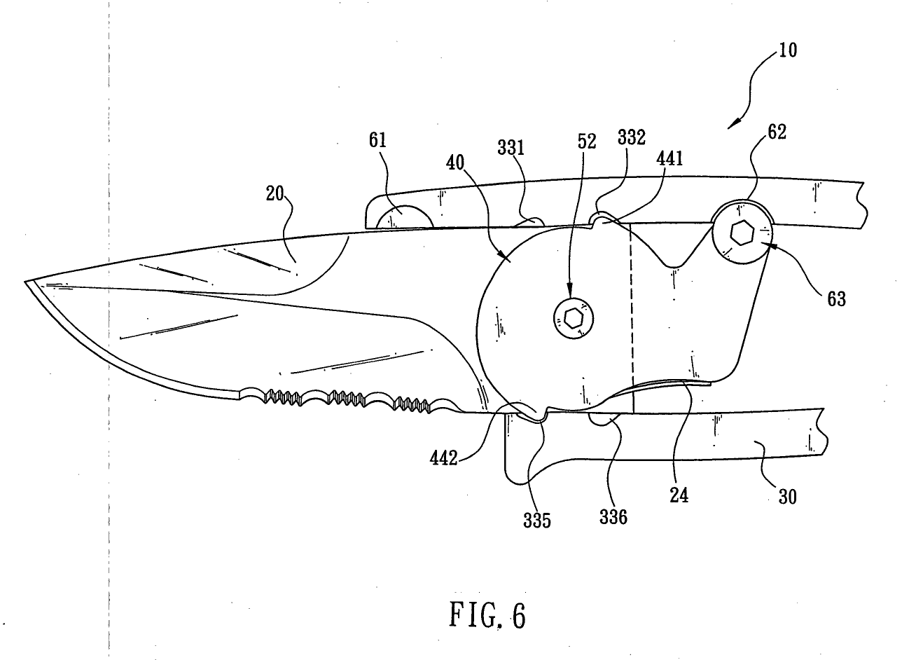

Referring to FIG. 6, the characteristics of a second preferred embodiment of the invention are detailed below. On the inner surface of the handle 30 at one prong thereof there are provided a first cavity 61 at a free end of one prong of the handle 30 and a second cavity 62 at a position between the first cavity 61 and a joining point of the prongs of the handle 30 in which a distance between the first cavity 61 and the second pivot axis 52 is equal to that between the second cavity 62 and the second pivot axis 52. An engagement member 63 is formed on a periphery of the latch 40 and is projected outwardly. During use the latch 40 is pivotably connected to the other end of the blade 20 with the engagement member 63 disposed externally of the blade 20 and distal the point 25 as shown in FIG. 1. To the contrary, in a case of the blade 20 pivotably connected to the handle 30 an outer end of the engagement member 63 distal the latch 40 is engaged with the first cavity 61 or the second cavity 62 in its locking state. In a case of the blade 20 received in the handle 30 or the point 25 is distal one end of the handle 30, the latch 40 and the corresponding detent 34 are brought in a locking state (see FIG. 2). At the same time, the engagement member 63 is engaged with the first cavity 61 or the second cavity 62. As a result, the locking engagement of the blade 20 and the handle 30 is more reliable.

While each of the latching elements 421 and 422 is implemented as a plate having an arc periphery in the embodiments, they may have other shapes and the number, constructions, and materials thereof may differ from the above depending on applications as long as the latching elements 421 and 422 can be pivotably connected to the blade 20 and are adapted to cause the detent 34 to lockingly engage the blade 20 with the handle 30. All of the above about the latching elements 421 and 422 are conceivable by the invention. In detail, for example the latching element is implemented as a plate having a curved, rectangular, or hexagonal periphery with two opposite sides thereof being formed as planes. Also, the latching element is flat. Therefore, in a case of the latching elements pivotably connected to the blade and the blade connected to the handle, two opposite sides of the latching elements and the detent are locked for fastening the blade at the handle. Alternatively, on the inner surface of the handle proximate the pivot axis thereof an elongated slot is formed on the inner surface of one prong of the handle and another elongated slot is formed on the inner surface of the other prong of the handle with the pivot axis formed therebetween. Also, the latching element is implemented as a plate having a curved, rectangular, or hexagonal periphery. As such, two opposite sides of the latching elements are adapted to enter the corresponding slots when the latching elements, the blade, and the handle are pivotably connected together. As a result, the blade is lockingly engaged with the handle.

While the invention herein disclosed has been described by means of specific embodiments, numerous modifications and variations could be made thereto by those skilled in the art without departing from the scope and spirit of the invention set forth in the claims.

What is claimed is:

1. A folding knife comprising:
a handle comprising a receiving space and a detent at its one end;
a blade comprising a point at one end and having the other end pivotably connected to one end of the handle, the blade adapted to either lie within the receiving space by pivoting in one direction or pull out of the receiving space by pivoting in the other opposite direction; and
a latch pivotably connected to the other end of the blade, the latch adapted to either lock with the detent for prohibiting the blade from pivoting when the blade is received in the receiving space in a closed position of the knife or the point is distal one end of the handle in an open position thereof or disengage from the detent for permitting the blade to pivot about the handle.

2. The folding knife of claim 1, wherein the other end of the blade is pivotably connected to one end of the handle by a first pivot axis such that the blade is adapted to pivot about the handle by turning on the first pivot axis, the other end of the blade is pivotably connected to the latch by a second pivot axis such that the latch is adapted to pivot about the handle by turning on the second pivot axis, and the second pivot axis is perpendicular with respect to the first pivot axis.

3. The folding knife of claim 1, wherein the receiving space is defined by an inner surface extended from one prong to the other prong of the handle, the receiving space is open to both sides, and one end of the receiving space is extended out of one end of the handle to cause the handle to have a V-shaped or U-shaped appearance.

4. The folding knife of claim 2, wherein the latch comprises a first engagement member pivotably connected to the other end of the blade, the first engagement member being disposed externally of the blade and being distal the point, and further comprising a resilient element provided at the other end of the blade distal the point and extended away from the other end of the blade, the resilient element being in contact with the first engagement member at its one side when the blade and the latch are pivotably connected together.

5. The folding knife of claim 4, wherein the latch comprises two opposite first and second latching elements with the other end of the blade received and sandwiched therebetween and pivotably connected together by the first pivot axis.

6. The folding knife of claim 5, further comprising a first through hole formed proximate one end of the handle, a second through hole formed proximate the other opposite end of the handle both at the detent, a first hole formed at one edge proximate the other end of the blade, and a second hole formed at the other edge proximate the other end of the blade both distal the point, and wherein the first hole is aligned with the first through hole and the second hole is aligned with the second through hole for permitting each of two pivot elements to drive either through the first through hole into the first hole or through the second through hole into the second hole for pivotably fastening and forming the first pivot axis to enable the blade and the handle to pivotably connect together.

7. The folding knife of claim 5, wherein each of the latching elements comprises a projecting catch formed at its periphery, each of the catches including a bore such that a fastener is adapted to drive through the bores to fasten the first engagement member.

8. The folding knife of claim 5, wherein each of the latching elements comprises a central aperture, and the other end of the blade is received and sandwiched between the latching elements, further comprising an opening formed at the other end of the blade, the opening adapted to align with the apertures when the other end of the blade is pivotably sandwiched between the latching elements such that a fastener is adapted to drive through one aperture, the opening, and the other aperture for forming the second pivot axis.

9. The folding knife of claim 6, wherein the detent comprises the first through hole formed proximate one end of the handle and the second through hole formed proximate the other opposite end of the handle, wherein on an inner surface of the handle proximate the second through hole there are provided a first recess, a second recess, a third recess, and a fourth recess, wherein on the inner surface of the handle proximate the first through hole there are provided a fifth recess, a sixth recess, a seventh recess, and an eighth recess, wherein at a periphery of one latching element there are formed a first protuberance and an opposite second protuberance, wherein at a periphery of the other latching element there are formed a third protuberance and an opposite fourth protuberance, and wherein each of the protuberances is adapted to engage with one of the recesses.

10. The folding knife of claim 2, wherein on an inner surface of the handle at one prong thereof there are provided a first cavity at a free end of one prong of the handle and a second cavity at a position between the first cavity and a joining point of the prongs of the handle, and wherein a distance between the first cavity and the second pivot axis is equal to that between the second cavity and the second pivot axis, and further comprising a second engagement member formed on a periphery of the latch and projected outwardly, wherein either the latch is pivotably connected to the other end of the blade with the second engagement member disposed externally of the blade and distal the point, or in response to pivotably connecting the blade to the handle an outer end of the second engagement member distal the latch is engaged with the first cavity or the second cavity in a locking state.
